(19) United States
(12) Patent Application Publication
(10) Pub. No.: US 2026/0066533 A1
(43) Pub. Date: Mar. 5, 2026

(54) ANTENNA AND ANTENNA DEVICE

(71) Applicant: Murata Manufacturing Co., Ltd., Nagaokakyo-shi (JP)

(72) Inventor: Kentaro KAWABE, Nagaokakyo-shi (JP)

(73) Assignee: Murata Manufacturing Co., Ltd., Nagaokakyo-shi (JP)

(21) Appl. No.: 19/383,842

(22) Filed: Nov. 10, 2025

Related U.S. Application Data
(63) Continuation of application No. PCT/JP2024/017011, filed on May 7, 2024.

(30) Foreign Application Priority Data
May 17, 2023 (JP) 2023-081308

(51) Int. Cl. H01Q 1/52; H01Q 9/04

(52) U.S. Cl. CPC H01Q 1/526; H01Q 9/0421

(57) ABSTRACT

An antenna includes a first radiating conductor having a first open end and a first feed point, a second radiating conductor that has a second open end and a second feed point and is disposed such that the second open end is opposite to the first open end, and a planar ground conductor that overlaps with the first radiating conductor and the second radiating conductor in plan view. The antenna includes also a shielding ground conductor disposed between the first open end and the second open end in plan view, an end portion ground conductor connected to the first radiating conductor and the second radiating conductor in plan view, and a feed line that feeds the first radiating conductor and the second radiating conductor with power with a predetermined phase difference from each other.

### CROSS-REFERENCE TO RELATED APPLICATIONS

The present application is a bypass continuation of PCT International Application No. PCT/JP2024/017011, filed May 7, 2024, which claims priority to Japanese patent application JP 2023-081308, filed May 17, 2023, the entire contents of each of which being incorporated herein by reference.

### TECHNICAL FIELD

The present disclosure relates to an antenna and an antenna device.

### BACKGROUND ART

Patent Document 1 discloses an array antenna including an inverted-F antenna and a plurality of parasitic elements that are grounded to a ground plate and function as a reflector and a director. This allows the array antenna of Patent Document 1 to improve the directivity in a radiation direction.

### CITATION LIST

### Patent Document

Patent Document 1: Japanese Unexamined Patent Application Publication No. 9-55621

### SUMMARY

### Technical Problems

The array antenna of Patent Document 1 radiates radio waves also in a direction other than the target radiation direction.

To address this problem, the present disclosure is directed to providing an antenna and an antenna device that can suppress unnecessary radiation and improve the directivity in a target radiation direction.

### Solutions to Problems

An antenna of the present disclosure includes a first radiating conductor having a first open end and a first feed point, a second radiating conductor that has a second open end and a second feed point and is disposed such that the second open end is opposite to the first open end, and a planar ground conductor that overlaps with the first radiating conductor and the second radiating conductor in plan view. The antenna includes also a shielding ground conductor disposed between the first open end and the second open end in plan view, an end portion ground conductor connected to the first radiating conductor and the second radiating conductor in plan view, and a feed line that feeds the first radiating conductor and the second radiating conductor with power with a predetermined phase difference from each other.

### Advantageous Effects

According to this disclosure, unnecessary radiation can be suppressed, and the directivity in a target radiation direction can be improved.

### BRIEF DESCRIPTION OF DRAWINGS

FIG. 1 is a plan view of an antenna 1.

FIG. 2 is a side sectional view of the antenna 1 at a position indicated by line A-A in FIG. 1.

FIG. 3 is a side sectional view for explaining radiation of the antenna 1.

FIG. 4 is a side sectional view for explaining radiation of the antenna 1.

FIG. 5 is a side sectional view for explaining radiation of the antenna 1.

FIG. 6 is a plan view of the antenna 1.

FIG. 7 is a plan view of the antenna 1.

FIG. 8 is a plan view of an antenna 1A according to modification 1.

FIG. 9 is a plan view of an antenna 1B according to modification 2.

FIG. 10 is a plan view of an antenna 1C according to modification 3.

FIG. 11 is a plan view of an antenna 1D according to modification 4.

FIG. 12 is a plan view of an antenna 1E according to modification 5.

FIG. 13 is a schematic side view of an antenna device including the antenna 1 and a flexible board 5 connected to the antenna 1.

### DESCRIPTION OF EMBODIMENTS

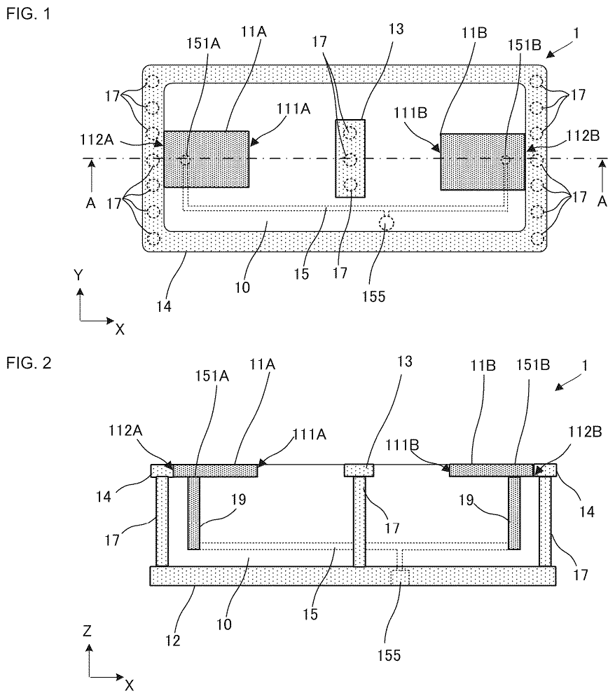

An antenna 1 according to an embodiment of the present disclosure is described below. FIG. 1 is a plan view of the antenna 1. FIG. 2 is a side sectional view of the antenna 1 at a position indicated by line A-A in FIG. 1.

The antenna 1 has a first radiating conductor 11A, a second radiating conductor 11B, a planar ground conductor 12, a shielding ground conductor 13, an end portion ground conductor 14, and a feed line 15. The first radiating conductor 11A has a first open end 111A and a first feed point 151A. The second radiating conductor 11B has a second open end 111B and a second feed point 151B. The first open end 111A and the second open end 111B are disposed opposite to each other.

The planar ground conductor 12 overlaps with the first radiating conductor 11A and the second radiating conductor 11B in plan view. The shielding ground conductor 13 is disposed between the first open end 111A and the second open end 111B in plan view. The end portion ground conductor 14 is connected to the first radiating conductor 11A and the second radiating conductor 11B at a first short-circuit end 112A and a second short-circuit end 112B in plan view. Due to this, end portions on the opposite side to the first open end 111A and the second open end 111B of the first radiating conductor 11A and the second radiating conductor 11B, respectively, are short-circuited.

In the present embodiment, the direction in which the first radiating conductor 11A, the shielding ground conductor 13, and the second radiating conductor 11B are arranged is an X-direction, and the direction orthogonal to this X-direction in plan view is a Y-direction.

The feed line 15 supplies power input from a feed conductor 155 to the first radiating conductor 11A and the second radiating conductor 11B through an interlayer connection conductor 19. The feed line 15 feeds the first radiating conductor 11A with the power at the first feed point 151A. Further, the feed line 15 feeds the second radiating conductor 11B with the power at the second feed point 151B.

The length of the first radiating conductor 11A in the X-direction is the ¼ wavelength of radio waves given in the power feed. The length of the second radiating conductor 11B in the X-direction is also the ¼ wavelength of radio waves given in the power feed. Therefore, the first radiating conductor 11A and the second radiating conductor 11B each configure an inverted-F antenna.

The length from the feed conductor 155 to the first feed point 151A is different from the length from the feed conductor 155 to the second feed point 151B. Therefore, the feed line 15 feeds the first radiating conductor 11A and the second radiating conductor 11B with power with a predetermined phase difference from each other. In the present embodiment, the length from the feed conductor 155 to the first feed point 151A is longer than the length from the feed conductor 155 to the second feed point 151B by the half wavelength. Therefore, the feed line 15 feeds the first radiating conductor 11A and the second radiating conductor 11B with power in opposite phases to each other.

The antenna 1 is formed of a base 10 with a rectangular parallelepiped shape. In the present embodiment, the direction toward the upper surface, of the thickness directions of the base 10, is a Z-direction. The base 10 is obtained by, for example, laminating thermoplastic resins. The thermoplastic resins are, for example, liquid crystal polymer resins. The thermoplastic resins may be, for example, polyetheretherketone (PEEK), polyetherimide (PEI), polyphenylene sulfide (PPS), polyimide (PI), or the like. Moreover, the base 10 may be composed of, for example, an insulator material other than the resin, such as a ceramic.

The first radiating conductor 11A, the second radiating conductor 11B, the shielding ground conductor 13, and the end portion ground conductor 14 are disposed at the upper surface of the base 10. The planar ground conductor 12 is disposed on the lower surface of the base 10.

The end portion ground conductor 14 is annularly formed to surround the first radiating conductor 11A, the second radiating conductor 11B, and the shielding ground conductor 13 in plan view. This allows the end portion ground conductor 14 to ground the first radiating conductor 11A and the second radiating conductor 11B and suppress unnecessary radiation in the X-direction and the Y-direction from the first radiating conductor 11A and the second radiating conductor 11B.

The first radiating conductor 11A and the second radiating conductor 11B have a rectangular shape long in the X-direction in plan view. The shielding ground conductor 13 has a rectangular shape long in the Y-direction in plan view. In the present embodiment, the length of the shielding ground conductor 13 in the Y-direction is longer than that of the first radiating conductor 11A and the second radiating conductor 11B in the Y-direction.

The shielding ground conductor 13 is connected to the planar ground conductor 12 through a plurality of interlayer connection conductors 17. The end portion ground conductor 14 is also connected to the planar ground conductor 12 through a plurality of interlayer connection conductors 17.

The planar ground conductor 12 is disposed on substantially the whole surface of the antenna 1 excluding the feed conductor 155 in plan view. This allows the planar ground conductor 12 to suppress unnecessary radiation in the −Z-direction from the first radiating conductor 11A and the second radiating conductor 11B.

Moreover, the antenna 1 of the present embodiment can enhance radiation in the Z-direction while suppressing radiation in the X-direction and the Y-direction.

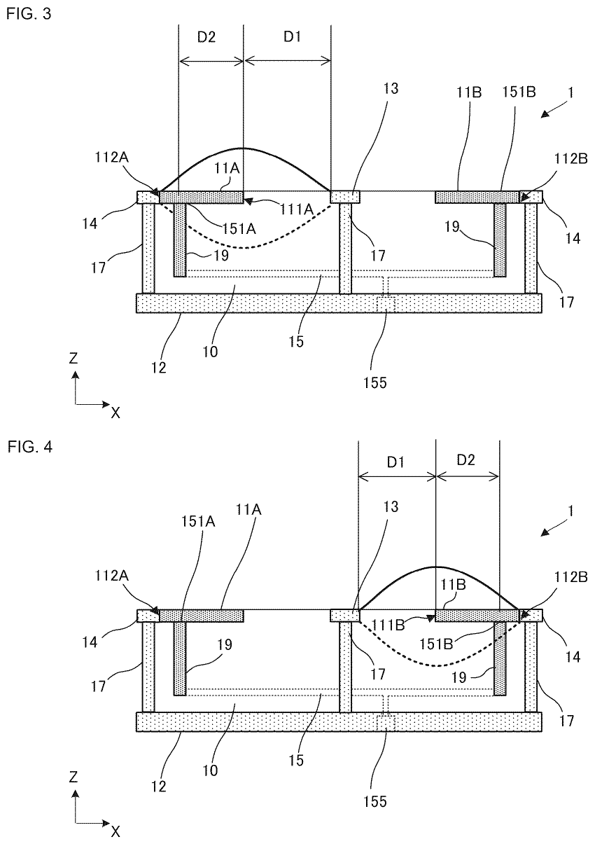

FIGS. 3, 4, and 5 are side sectional views for explaining radiation of the antenna 1. FIG. 3 schematically depicts voltage distribution of radio waves radiated in the X-direction from the first radiating conductor 11A.

Further, in this embodiment, the length of a first distance D1 between the position closest to the first radiating conductor 11A in the shielding ground conductor 13 and the first open end 111A is longer than a second distance D2 between the first open end 111A and the first feed point 151A. Thus, the radio waves radiated from the first radiating conductor 11A and radio waves reflected by the shielding ground conductor 13 are offset, e.g., are at least partially canceled through destructive interference.

FIG. 4 schematically depicts voltage distribution of radio waves radiated in the X-direction from the second radiating conductor 11B. Moreover, in this embodiment, the length of the first distance D1 between the position closest to the second radiating conductor 11B in the shielding ground conductor 13 and the second open end 111B is longer than the second distance D2 between the second open end 111B and the second feed point 151B. Thus, the radio waves radiated from the second radiating conductor 11B and radio waves reflected by the shielding ground conductor 13 are offset, e.g., are at least partially canceled through destructive interference.

As described above, the shielding ground conductor 13 can suppress unnecessary radiation in the X-direction from the first radiating conductor 11A and the second radiating conductor 11B.

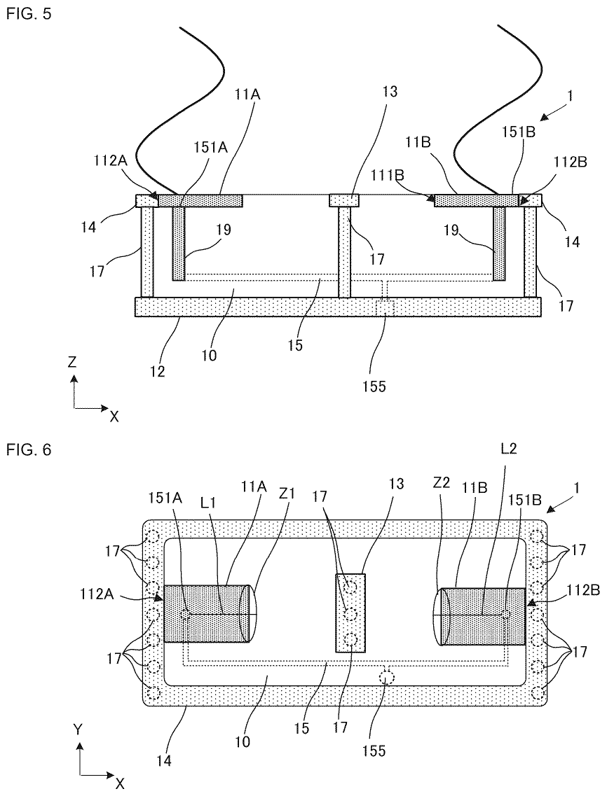

FIG. 5 schematically depicts voltage distribution of radio waves radiated in the Z-direction from the first radiating conductor 11A and the second radiating conductor 11B. The feed line 15 feeds the first radiating conductor 11A and the second radiating conductor 11B with power in opposite phases to each other. Because the first radiating conductor 11A and the second radiating conductor 11B are opposite to each other, the radio waves radiated in the Z-direction from the first radiating conductor 11A and the second radiating conductor 11B are in the same phase and enhance each other.

This allows the antenna 1 of the present embodiment to suppress radiation in directions other than the Z-direction and radiate radio waves having strong directivity in the Z-direction as the target direction.

As depicted in FIG. 6, in the present embodiment, the first radiating conductor 11A and second radiating conductor 11B are arranged along an X-direction. A first straight line L1 is defined as a line passing through the first feed point 151A and extending in the Y-direction, orthogonal to the X-direction. Similarly, a second straight line L2 is defined as a line passing through the second feed point 151B and extending in the Y-direction. In the present embodiment, the feed line 15 does not intersect the first straight line L1 or the second straight line L2.

Due to this, the feed line 15 is not disposed at a place where an electric field is strong, and thus unnecessary coupling between the feed line 15 and the first radiating conductor 11A and the second radiating conductor 11B can be suppressed.

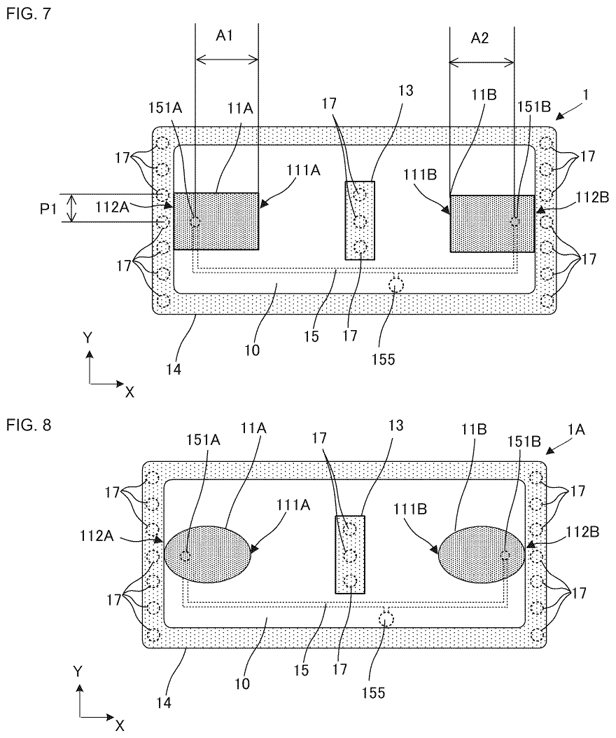

Further, as depicted in FIG. 7, in the present embodiment, when the distance between the first open end 111A and the first feed point 151A is defined as A1 and the distance between the second open end 111B and the second feed point 151B is defines as A2, a distance P1 between the respective two of the interlayer connection conductors 17 is equal to or shorter than twice the shorter distance of the distance A1 and the distance A2. That is, the interval of the interlayer connection conductors 17 may be equal to or shorter than the ½ wavelength. When the interval of the interlayer connection conductors 17 is equal to or shorter than the ½ wavelength, the radio waves radiated from the first radiating conductor 11A and the second radiating conductor 11B can be reflected, and unnecessary radiation in the X-direction can be suppressed.

### MODIFICATION 1

FIG. 8 is a plan view of an antenna 1A according to modification 1. The shapes of the first radiating conductor 11A and the second radiating conductor 11B of the antenna 1A in plan view are elliptical shapes. The other configuration is the same configuration as the antenna 1 depicted in FIGS. 1 and 2.

Also in this case, the shielding ground conductor 13 is disposed between the first open end 111A and the second open end 111B in plan view. Therefore, the shielding ground conductor 13 of the antenna 1A can also suppress unnecessary radiation in the X-direction from the first radiating conductor 11A and the second radiating conductor 11B.

### MODIFICATION 2

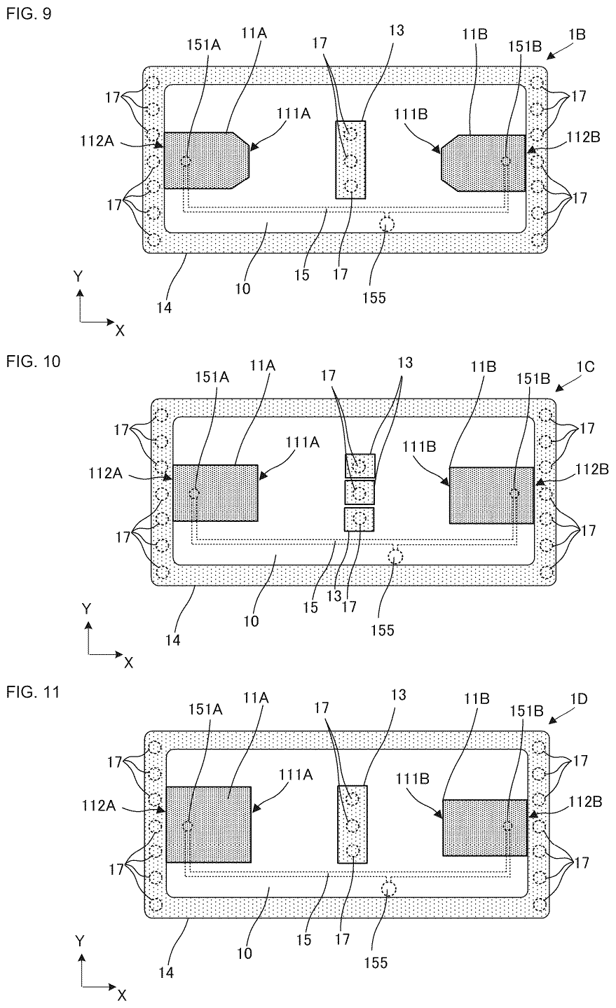

FIG. 9 is a plan view of an antenna 1B according to modification 2. The shapes of the first radiating conductor 11A and the second radiating conductor 11B of the antenna 1B in plan view are pentagonal shapes obtained by cutting the corners of the first open end 111A and the second open end 111B to form tapered shapes. The other configuration is the same configuration as the antenna 1 depicted in FIGS. 1 and 2.

Also in this case, the shielding ground conductor 13 is disposed between the first open end 111A and the second open end 111B in plan view. Therefore, the shielding ground conductor 13 of the antenna 1A can also suppress unnecessary radiation in the X-direction from the first radiating conductor 11A and the second radiating conductor 11B.

As depicted in FIGS. 8 and 9, the shapes of the first radiating conductor 11A and the second radiating conductor 11B in plan view are not limited to the rectangular shape.

### MODIFICATION 3

FIG. 10 is a plan view of an antenna 1C according to modification 3. In the antenna 1C, dividing into a plurality of (in FIG. 10, three) shielding ground conductors 13 is made. The shielding ground conductors 13 are each connected to the planar ground conductor 12 through the interlayer connection conductor 17.

As described above, the number of shielding ground conductors 13 is not required to be one. The interval of the shielding ground conductors 13 may be equal to or shorter than the ½ wavelength. When the interval of the shielding ground conductors 13 is equal to or shorter than the ½ wavelength, the radio waves radiated from the first radiating conductor 11A and the second radiating conductor 11B can be reflected.

### MODIFICATION 4

FIG. 11 is a plan view of an antenna 1D according to modification 4. The shapes of the first radiating conductor 11A and the second radiating conductor 11B of the antenna 1D in plan view have the same configuration as the antenna 1 depicted in FIGS. 1 and 2. However, the length of the first radiating conductor 11A in the Y-direction is longer than that of the second radiating conductor 11B in the Y-direction.

Also in this case, the shielding ground conductor 13 is disposed between the first open end 111A and the second open end 111B in plan view. Further, the length of the shielding ground conductor 13 in the Y-direction is the same as that of the first radiating conductor 11A in the Y-direction, and is longer than that of the second radiating conductor 11B in the Y-direction.

That is, the length of the shielding ground conductor 13 in the Y-direction is equal to or longer than the length of a place with the longest length in the Y-direction in the first radiating conductor 11A or the second radiating conductor 11B.

Also in this case, the shielding ground conductor 13 of the antenna 1D can also suppress unnecessary radiation in the X-direction from the first radiating conductor 11A and the second radiating conductor 11B.

### MODIFICATION 5

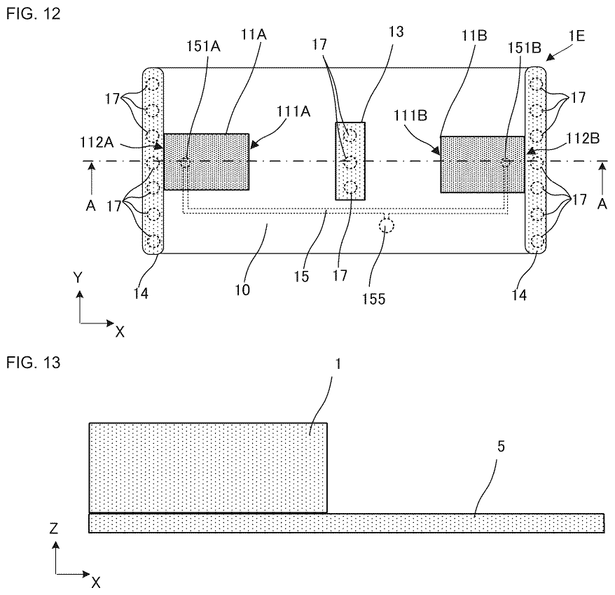

FIG. 12 is a plan view of an antenna 1E according to modification 5. The end portion ground conductor 14 of the antenna 1E is not annular but disposed only at end portions in the X-direction. Moreover, the length of the end portion ground conductor 14 in the Y-direction is longer than that of the first radiating conductor 11A and the second radiating conductor 11B in the Y-direction.

Also in this case, the end portion ground conductor 14 can suppress unnecessary radiation in the X-direction.

### Another Example

FIG. 13 is a schematic side view of an antenna device including the antenna 1 and a flexible board 5 connected to the antenna 1. The lower surface of the antenna 1 is joined to the upper surface of the flexible board 5.

The flexible board 5 is composed of, for example, a material having bendability, such as a liquid crystal polymer resin, polyetheretherketone (PEEK), polyetherimide (PEI), polyphenylene sulfide (PPS), or polyimide (PI).

The flexible board 5 can be bent at any position because having the bendability. Therefore, the antenna device depicted in FIG. 13 can adjust the radiation direction of the antenna 1 to any direction.

It should be thought that the description of the present embodiment is an example in terms of all points and is not restrictive. The scope of the present invention is shown by not the above-described embodiment but the scope of claims. Moreover, it is intended that meanings equivalent to the scope of claims and all changes in the scope are included in the scope of the present invention.

The present invention has the following configurations.

<1>

An antenna comprising:
a first radiating conductor having a first open end and a first feed point;
a second radiating conductor that has a second open end and a second feed point and is disposed such that the second open end is opposite to the first open end;
a planar ground conductor that overlaps with the first radiating conductor and the second radiating conductor in plan view;
a shielding ground conductor disposed between the first open end and the second open end in plan view;
an end portion ground conductor connected to the first radiating conductor and the second radiating conductor in plan view; and
a feed line that feeds the first radiating conductor and the second radiating conductor with power with a predetermined phase difference from each other.
   <2>

The antenna according to <1>, wherein
the end portion ground conductor is formed to surround the first radiating conductor, the second radiating conductor, and the shielding ground conductor in plan view of the antenna.
   <3>

The antenna according to <1> or <2>, wherein
the feed line feeds the first radiating conductor and the second radiating conductor with power in opposite phases to each other.
   <4>

The antenna according to any of <1> to <3>, wherein
a direction in which the first radiating conductor, the shielding ground conductor, and the second radiating conductor are arranged is defined as an X-direction, and a direction orthogonal to the X-direction in plan view is defined as a Y-direction, and
length of the shielding ground conductor in the Y-direction is equal to or longer than length of a place with a longest length in the Y-direction in the first radiating conductor or the second radiating conductor.
   <5>

The antenna according to any of <1> to <4>, wherein
a first distance D1 between a position closest to the first radiating conductor or the second radiating conductor in the shielding ground conductor and the first open end or the second open end is longer than a second distance D2 between the first open end or the second open end and the first feed point or the second feed point.
   <6>

The antenna according to any of <1> to <5>, wherein
a straight line drawn from the first feed point orthogonally to a first region closest to the second radiating conductor in the first radiating conductor is defined as a first straight line,
a straight line drawn from the second feed point orthogonally to a second region closest to the first radiating conductor in the second radiating conductor is defined as a second straight line, and
the feed line intersects neither the first straight line nor the second straight line.
   <7>

The antenna according to any of <1> to <6>, wherein
the antenna has a plurality of interlayer connection conductors that connect the planar ground conductor to the end portion ground conductor and the shielding ground conductor,
a distance between the first open end and the first feed point is defined as A1,
a distance between the second open end and the second feed point is defined as A2,
a distance P1 between respective two of the plurality of interlayer connection conductors is equal to or shorter than twice the shorter distance of the distance A1 and the distance A2.
   <8>

An antenna device comprising:
the antenna according to any of <1> to <7>; and
a flexible board connected to the antenna.

### Reference Signs List

1 antenna
1A antenna
1B antenna
1C antenna
1D antenna
1E antenna
5 flexible board
10 base
11A first radiating conductor
11B second radiating conductor
12 planar ground conductor
13 shielding ground conductor
14 end portion ground conductor
15 feed line
17 interlayer connection conductor
19 interlayer connection conductor
111A first open end
111B second open end
112A first short-circuit end
112B second short-circuit end
151A first feed point
151B second feed point
155 feed conductor
A1 distance
A2 distance
D1 first distance
D2 second distance
L1 first straight line
L2 second straight line
P1 distance

1. An antenna comprising:
a first radiating conductor having a first open end and a first feed point;
a second radiating conductor having a second open end and a second feed point, the second radiating conductor being disposed such that the second open end is opposite to the first open end;
a planar ground conductor that overlaps with the first radiating conductor and the second radiating conductor in plan view;
a shielding ground conductor between the first open end and the second open end in plan view;
an end portion ground conductor connected to the first radiating conductor and the second radiating conductor in plan view; and
a feed line that feeds the first feed point and the second feed point with power with a predetermined phase difference from each other.

2. The antenna according to claim 1, wherein
the end portion ground conductor surrounds the first radiating conductor, the second radiating conductor, and the shielding ground conductor in plan view of the antenna.

3. The antenna according to claim 1, wherein
the feed line feeds the first feed point and the second feed point with power in opposite phases to each other.

4. The antenna according to claim 3, wherein the feed line is configured such that an electrical length from a power input to the first feed point and an electrical length from the power input to the second feed point differ by a half wavelength of an operating frequency of the antenna.

5. The antenna according to claim 1, wherein
a direction in which the first radiating conductor, the shielding ground conductor, and the second radiating conductor are arranged is defined as an X-direction, and a direction orthogonal to the X-direction in plan view is defined as a Y-direction, and
length of the shielding ground conductor in the Y-direction is equal to or longer than length of a place with a longest length in the Y-direction in the first radiating conductor or the second radiating conductor.

6. The antenna according to claim 1, wherein
a first distance D1 between a position closest to the first radiating conductor or the second radiating conductor in the shielding ground conductor and the first open end or the second open end is longer than a second distance D2 between the first open end or the second open end and the first feed point or the second feed point.

7. The antenna according to claim 1, wherein
a first straight line is defined as a line passing through the first feed point and extending in a orthogonal direction to an axis connecting the first open end and the second open end,
a second straight line is defined as a line passing through the second feed point and extending in the orthogonal direction, and
the feed line intersects neither the first straight line nor the second straight line.

8. The antenna according to claim 1, wherein
the antenna has a plurality of interlayer connection conductors that connect the planar ground conductor to the end portion ground conductor and the shielding ground conductor, and
a distance between the first open end and the first feed point is defined as A1,
a distance between the second open end and the second feed point is defined as A2, and
a distance P1 between adjacent interlayer connection conductors of the plurality of interlayer connection conductors is equal to or shorter than twice the shorter distance of the distance A1 and the distance A2.

9. The antenna according to claim 1, wherein the first radiating conductor and the second radiating conductor each have a length along an X-direction of a quarter wavelength of an operating frequency of the antenna.

10. The antenna according to claim 1, wherein the shielding ground conductor includes a plurality of discrete shielding ground conductors arranged between the first open end and the second open end in plan view.

11. The antenna according to claim 10, wherein an interval between adjacent shielding ground conductors of the plurality of discrete shielding ground conductors is equal to or shorter than a half wavelength of an operating frequency of the antenna.

12. An antenna device comprising:
the antenna according to claim 1; and
a flexible board connected to the antenna.

13. An antenna comprising:
a first radiating conductor having a first open end and a first feed point;
a second radiating conductor having a second open end and a second feed point, the second radiating conductor being disposed such that the second open end is opposite to the first open end;
a planar ground conductor that overlaps with the first radiating conductor and the second radiating conductor in plan view;
a shielding ground conductor disposed between the first open end and the second open end in plan view;
an end portion ground conductor connected to the first radiating conductor and the second radiating conductor in plan view; and
a feed line having a first path extending from a common power input to the first feed point and a second path extending from the common power input to the second feed point, wherein the first path and the second path have different electrical lengths.

14. The antenna according to claim 13, wherein the difference between the electrical lengths of the first path and the second path is a half wavelength of an operating frequency of the antenna.

15. The antenna according to claim 13, wherein the end portion ground conductor is formed to surround the first radiating conductor, the second radiating conductor, and the shielding ground conductor in plan view of the antenna.

16. The antenna according to claim 13, wherein
the feed line feeds the first feed point and the second feed point with power in opposite phases to each other.
